(19) United States
(12) Patent Application Publication
(10) Pub. No.: US 2007/0054630 A1
(43) Pub. Date: Mar. 8, 2007

(54) Arrangement and method for supplying electrical power to a field device in a process installation without the use of wires

(76) Inventors: Guntram Scheible, Hirschberg (DE); Thomas Keul, Freigericht (DE); Rolf Merte, Marburg (DE); Dietmar Overhoff, Freigericht (DE); Heinrich Deckamnn, Langenselbold (DE); Ralf Huck, Hanau (DE)

Correspondence Address: BUCHANAN, INGERSOLL & ROONEY PC, POST OFFICE BOX 1404, ALEXANDRIA, VA, 22313-1404, US

(21) Appl. No.: 10/547,191

(22) PCT Filed: Mar. 13, 2003
(86) PCT No.: PCT/EP03/02529

§ 371 Date: Aug. 29, 2006

(51) Int. Cl. H04B 1/38

(52) U.S. Cl. 455/90.3

(57) ABSTRACT

An arrangement is described for supplying electrical power to a field device (10) with a housing (11) for monitoring a technical process in a process installation, without the use of wires, which field device (10) has a wire-free communication interface (5). The field device (10) has at least one field device face (11a) facing the process and at least one field device face (11b, c, d) facing away from the process, and is equipped with a thermoelectric transducer (14) which has a transducer face (14b) facing the process and a transducer face (14c) facing away from the process. The heat flow in the field device between the field device face (11a) facing the process and the field device face (11b, c, d) facing away from the process is converted into electrical energy by the thermoelectric transducer (14), and this conversion process may be bidirectional.

### DESCRIPTION

The invention relates to an arrangement for supplying electrical power to a field device in a process installation which is equipped with a wire-free communication interface, without the use of wires, as claimed in the precharacterizing clause of claim 1. The invention also relates to a method for supplying electrical power to a field device in a process installation without the use of wires, as claimed in the precharacterizing clause of claim 6.

Field devices which are equipped with a wire-free communication interface, for example a GPRS, Bluetooth or some other low-energy interface such as ZigBee are known from use in process installations, with a device such as this having not only a sensor/actuating unit, which comprises the actual measurement or control module, a control, data acquisition and processing module as well as the wire-free communication interface, but also a power generating and production unit for supplying power to the field device within a housing, without the use of wires. In this case, one variant of a power generating and production unit which appears to be particularly advantageous converts non-electrical primary energy that exists in the process in the process installation to electrical energy, with the field device being supplied with electrical power in this way, since this avoids the disadvantage that conventional primary energy sources, such as batteries, can be exhausted. DE 101 20 100 A1 has proposed a system such as this which is used to supply field devices with a wire-free communication device for use in process installations with so-called non-conventional primary energy generators, for example a thermoelectric transducer, by means of which a temperature difference between two media at different temperatures is converted to electrical power. DE 201 07 112 U1 describes a device for supplying power to field devices in process installations which are equipped with a wire-free communication interface for interchanging data with a central device, in which the field device is equipped with a thermoelectric transducer by means of which the physical variable comprising the temperature difference between two media at different temperatures is converted to electrical power. The thermoelectric transducer in the device according to DE 201 07 112 U1 is in this case formed from a thermocouple between two sensing points, with the first sensing point projecting through the wall of the pipeline of the technical process into the process medium, and the second sensing point being located within or outside the field device, in each case at the ambient temperature level. However, an arrangement such as this results in the difficulty that the first sensing point, which projects into the process medium, of the thermoelectric transducer must be particularly protected against corrosion and contamination, thus adversely affecting the heat, so that, in particular, the heat transfer from the medium to the sensing point, and thus the efficiency of the thermoelectric transducer become worse over the course of time. Furthermore, fitting of the thermoelectric transducer with its sensing point end into the interior of the process medium represents considerable design complexity; there are also some locations in which field devices are used in process installations in which it is completely impossible for a component to be immersed directly in the process medium, for installation reasons. Furthermore, the efficiency of a thermoelectric transducer which makes use of the temperature difference between two media at different temperatures is, of course, restricted. The capability to use a power supply device according to DE 201 07 112 U1 is thus severely restricted in practice.

The object of the present invention is thus to provide an arrangement for supplying a field device in a process installation which is equipped with a wire-free communication interface without the use of wires with electrical power, using a thermoelectric transducer which avoids the disadvantages of the known arrangements, and to develop a method for supplying a field device in a process installation which is equipped with a wire-free communication interface with electrical power, without the use of wires.

With regard to the arrangement, the object is achieved by the characterizing features of claim 1, and with regard to the method it is achieved by the characterizing features of claim 6.

According to the invention, the thermoelectric transducer is thus arranged in or on the field device outside the pipelines which carry the process medium, such that the heat flow in the field device between the field device face facing the process and the field device face facing away from the process and/or the heat flow through the thermoelectric transducer between the transducer face facing the process and the transducer face facing away from the process can be converted to electrical energy by the thermoelectric transducer.

The advantage of a device according to the invention such as this is that contamination or corrosion of the thermoelectric transducer is largely avoided and, furthermore, that the use of the heat flow, that is to say the power per unit area, expressed in W/m², makes it possible to achieve considerably greater efficiency from the thermoelectric transducer. In this case, thermoelectric transducers which use the heat flow passing through them to produce electrical energy are known in principle, although, until now, the feasibility to use them in conjunction with field devices in process installations which are equipped with a wire-free communication interface has been denied by the specialist world. As has now surprisingly been found, they can be used very well and advantageously for the production of electrical energy for field devices in process installations, to be precise for all types of field devices, from temperature sensors via flowmeters to analysis devices such as pH meters or conductivity meters.

In one particular advantageous refinement of the invention, the heat flow in the field device between the field device face facing the process and the field device face facing away from the process, and/or the heat flow through the thermoelectric transducer between the transducer face facing the process and the transducer face facing away from the process can be converted to electrical energy irrespective of the direction of the heat flow. This means that, even in situations in which—for example the process medium is cooled to a major extent—the process media temperature falls below the ambient temperature, the thermoelectric transducer still produces electrical energy, thus ensuring that electrical power is supplied to the field device without any interruption.

It is highly advantageous for the thermoelectric transducer to be connected to a heat sink on the transducer face facing away from the process. This creates a defined, good path for the heat flow in a simple manner.

A further advantageous refinement option for the invention provides that the thermoelectric transducer is fitted entirely within the housing of the field device and the heat sink is fitted at least partially within the housing of the field device and represents a part of the housing, because this then ensures a particularly compact and modular design, with few components.

In another highly advantageous embodiment, the field device is equipped with an energy store and an energy management system, which is integrated in the controller or in the control, data acquisition and processing module. The energy management system makes it possible to minimize the total energy consumption of the field device. In this case, the energy management system can be connected via the wire-free communication interface to a control station, or else to a central control and/or service station. If, by way of example, no thermoelectric voltage or only a very small thermoelectric voltage is produced, then this may be because no process medium is actually present. The control station or the central service station can determine this on the basis of measured values from other field devices. If this is confirmed, the field device could be switched by the control station to a reduced activity state, and thus to a reduced power consumption state, until the presence of the process medium is identified once again.

Fundamentally, the abovementioned advantages can be exploited with all types of field devices, but in particular in the case of field devices with a total power consumption of a few milliwatts. These are in particular temperature sensors and transmitters, in which, just by virtue of their installation location in the technical process, which is generally a process point whose temperature is higher than that of the environment, a large heat flow is ensured, at least at times, through the field device or through the thermoelectric transducer.

With regard to the method for supplying electrical power to a field device in a process installation which is equipped with a wire-free communication interface without the use of wires, the essence of the invention is that the thermoelectric transducer is arranged outside the pipelines which carry the process media, and that the heat flow in the field device between the field device face facing the process and the field device face facing away from the process, and/or the heat flow through the thermoelectric transducer between the transducer face facing the process and the transducer face facing away from the process is converted to electrical energy by the thermoelectric transducer.

In this case, the heat flow in the field device between the field device face facing the process and the field device face facing away from the process, and/or the heat flow through the thermoelectric transducer between the transducer face facing the process and the transducer face facing away from the process is converted to electrical energy irrespective of the direction of the heat flow.

One advantageous refinement of the method consists in that a defined path for the heat flow in the field device is created by means of a heat sink which is fitted on the transducer face facing away from the process.

It is also highly advantageous for the energy consumption of the field device to be minimized by means of an energy management system, with the energy management system being integrated in the controller or in the control, data acquisition and processing module, and being connected via the wire-free communication interface with a central control and/or service station. In particular, it is advantageous for the energy consumption of the field device to be minimized as a function of the state of a store and/or of the actual measurement variables and/or of their rate of change with time and/or of the instantaneous installation state, which is known to the central control and/or service station.

Further advantageous refinements and improvements of the invention are specified in the further dependent claims.

The invention as well as further advantageous refinements and improvements and further advantages of the invention will be explained and described in more detail with reference to the drawings, which illustrate two exemplary embodiments of the invention, and in which:

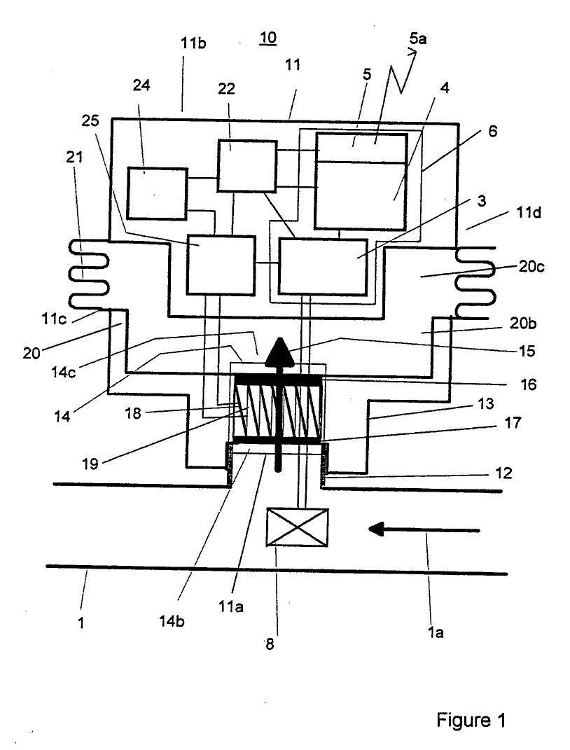

FIG. 1 shows a schematic illustration of a first embodiment of the invention, having a thermoelectric transducer and heat sink integrated in the field device, and

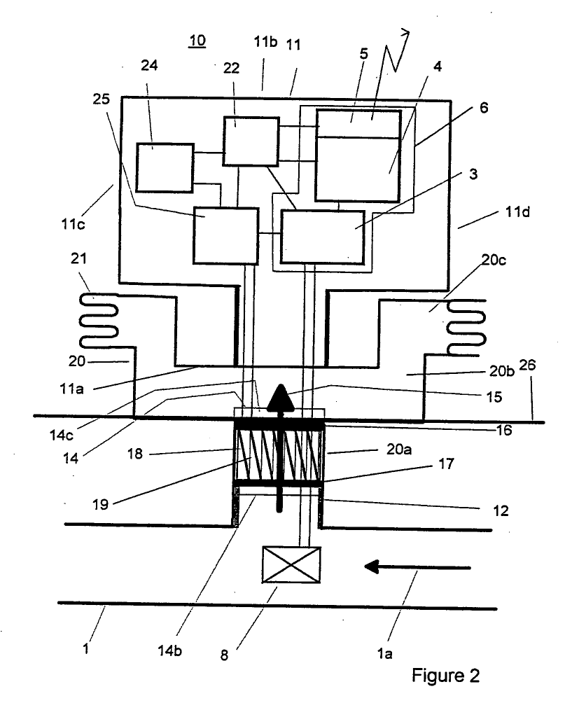

FIG. 2 shows a schematic illustration of a second embodiment of the invention.

FIG. 1 thus shows a first embodiment of an arrangement for supplying power without the use of wires to a field device 10 which, in the example shown here, represents a temperature measurement device for measurement of the temperature of a process medium which is being carried in a pipeline 1 of a technical process and is represented by an arrow 1a in FIG. 1. The field device 10 is surrounded by a housing 11 and has a sensor/actuating unit 6, which comprises the actual measurement module 3, a control, data acquisition and processing module 4 and a wire-free communication interface 5, as well. The measurement module 3 is connected via a two-wire or four-wire cable to a temperature sensor 8, which is immersed in the process medium through an opening in the pipeline 1. The field device 10 is connected via a connecting means 12, in this case a pipe connecting stub, to the pipeline 1. This defines a field device face 11a facing the process, as well as further field device faces 11b, 11c, 11d facing away from the process.

On the field device face 11a facing the process, the field device 10 has a hollow cylindrical attachment 13, which is arranged in the form of a collar on the field device 10 so that it is oriented away from the field device face 11a facing the process towards the pipeline 1. This hollow cylindrical attachment 13 provides the connection to the connecting means 12 and thus to the pipeline 1, and is preferably composed of a thermally poorly conductive material, for example plastic or a composite material.

A thermoelectric transducer 14 in the form of a cylindrical disc is fitted axially in the interior of the hollow cylindrical attachment 13, with the external diameter of this thermoelectric transducer 14 corresponding to the internal diameter of the hollow cylindrical attachment 13 and partially projecting into the interior of the field device 10, in the direction of its axial extent. The arrangement of the thermoelectric transducer 14 within the hollow cylindrical attachment 13 results in the definition of a transducer face 14b facing the process and a transducer face 14c facing away from the process, on it. The transducer face facing away from the process is also referred to as the environment side. The thermoelectric transducer 14 is provided on the transducer face 14b facing the process with a heat conduction means. 17 on the process side, for improved thermal coupling to the technical process. In a corresponding manner, the thermoelectric transducer 14 is provided on the transducer face 14c facing away from the process with a heat conduction means 14 on the environment side.

On the transducer face 14c facing away from the process, the transducer 14 (which is firmly connected to its heat conduction means 16 on the environment side) is connected to a heat sink 20, which is arranged in the interior of the field device 10. The heat sink 20 essentially comprises a cylindrical disc 20b, whose external diameter is somewhat less than the internal diameter of the housing 11, and a hollow cylindrical ring 20c which is fitted to the cylindrical disc 20b on the side facing the housing interior and radially overhangs the outside of the housing 11. The outer circumferential surface of the hollow cylindrical ring 20c is thus located outside the housing 11 and has a meandering surface contour, so that this results in cooling ribs 21, thus greatly enlarging the surface of the heat sink 20 which points outwards into the environment. The heat sink 20 is composed overall of a highly thermally conductive material, for example copper, aluminum or a corresponding metal alloy although it could just as well be a highly thermally conductive ceramic. The heat sink 20 designed in this way in conjunction with the heat conduction means 16 on the environment side thus ensures a very good thermal connection between the transducer face 14c facing away from the process and the area surrounding the field device. On the assumption that the temperature of the process medium 1a is higher than the ambient temperature, this results in a heat flow which is symbolized in FIG. 1 by the arrow 15 and which, starting from the heat conduction means 17 on the process side, passes through the thermoelectric transducer 14 and is passed via the heat conduction means 16 on the environment side, and via the heat sink 20 so that considered overall, the heat flow 15 in the field device 10 runs between the field device face 11a facing the process and the field device face 11c, 11d facing away from the process.

The thermoelectric transducer 14 converts the heat flow to electrical energy in a manner that is known per se. For this purpose, a number of thermocouples are connected in series in the interior of the thermoelectric transducer, each of which comprises one limb of a first material 18 and one limb of a second material 19. The first material 18 and the second material 19 may be formed from any material pairs which exhibit the Seebeck effect, which is known from physics and from the prior art, for example Pt/PtRh, Ni/NiCr, Si/Ge. The Seebeck effect itself will not be explained in any more detail here, and reference should be made to the relevant physics text books, for example to Hering, Martin, Storer, Physik für Ingenieure [Physics for Engineers], VDI Verlag Düisseldorf, 1992, pages 686 et seqq. The first material 18 and the second material 19 are connected to one another on the transducer face 14b facing the process, such that there is a good thermal contact with the heat conduction means 17 on the process side, for example by soldering. On the transducer face facing away from the process, the first and second materials of two adjacent thermocouples are connected to one another, for example by soldering, such that there is good thermal contact with the heat conduction means on the environment side. This results in an electrical series circuit, but in a thermal parallel circuit of a large number of thermocouples within the thermoelectric transducer.

The electrical voltage which is produced by the heat flow 15 in the thermoelectric transducer 14 is tapped off by means of two wires, which run through suitable bushings in the heat sink 20 from the thermoelectric transducer 14 into the interior of the field device 10, and this voltage is supplied to the other field device components via a converter rectifier 25, which is arranged in the field device 10. These components are the sensor/actuator unit 6 with the measurement module 3 integrated in it, the control, data acquisition and processing module 4 and the wire-free communication interface 5, as well as a controller 22 and an energy store 24. The electrical energy produced in the thermoelectric transducer 14 is stored in the energy store 24 in order to make it possible to provide sufficient electrical energy to supply all of the functions of the field device 10 if the primary energy supply falls briefly, that is to say if the heat flow 15 falls briefly. The controller 22 is connected to all of the assemblies in the field device and controls the internal procedure for measurement, data transmission, appropriate configuration of the field device, via the wire-free communication interface 5, and the energy management of the field device 10. The arrow 5a symbolizes the wire-free data and/or signal interchange of the field device 10 via the wire-free communication interface 5 with a central control and/or service station, which is located outside the field device 10, is not illustrated here and which, for example, may be a central control and host computer.

The converter rectifier 25 ensures that the field device 10 is also supplied with electrical energy in situations in which the heat flow through the thermoelectric transducer is running in the opposite direction, that is to say in the direction from the environment into the technical process. This may be the case, for example, when the technical process requires major cooling of the process medium below the ambient temperature, or when the ambient temperature rises to a major extent with a normal process medium temperature, for example as a result of solar radiation. The embodiment of the invention described here thus allows the field device 10 to be supplied with electrical power in a very universal manner. In order to make it possible to operate with the low voltages of the thermoelectric transducer, it is advantageous to use a synchronous rectifier, which is known per se, with MOSFETs, followed by an increase in voltage, as a converter rectifier. Another feasible implementation of the converter rectifier uses two reverse-parallel step-up controllers.

FIG. 2 shows a further embodiment of the subject matter of the invention. In the embodiment shown in FIG. 2, the thermoelectric transducer 14 with the heat sink 20 fitted to it is not arranged within the field device 10 but outside it, to be precise between the pipeline 1 and the field device face 11a facing the process. The internal design of the field device 10, the design of the heat sink 20, the design of the thermoelectric transducer 14 and of the technical process are otherwise the same in the embodiment shown in FIG. 2 as described in the embodiment shown in FIG. 1, with identical components being annotated with the same reference symbols. In addition a shield which is referred to as a heat shield 26 is also fitted between the side of the heat sink 20 facing the process and the pipeline 1 in the embodiment shown in FIG. 2, and is in the form of a disc with an external diameter which is somewhat larger than the external diameter of the heat sink 20. The function of the heat shield is to shield the heat sink 20 and the pipeline 1 from one another thermally, in particular with respect to mutual influencing resulting from radiation or convection, so that the temperature difference between the surrounding area and the technical process always assumes the greatest possible value, so that the heat flow 15 through the thermoelectric transducer 14 is thus also maximized.

A further advantage of the embodiment shown in FIG. 2 is the modular design. The heat sink 20 with the heat shield 26 and the thermoelectric transducer 14 form a power supply module which can be connected to the technical process independently of the field device 10 that is used via a connecting means 12, in this case a pipe connecting stub, and which then allows the connection of a range of different field devices.

The exemplary embodiments illustrated in the two FIGS. 1 and 2 represent only a small number of the large number of possible implementation options of devices according to the invention. All feasible types of field devices with devices according to the invention can be connected to all feasible types of technical processes or process sections in a flexible manner, where they allow the field devices to be supplied with electrical power without the use of wire and reliably over long periods.

### LIST OF REFERENCE SYMBOLS

1 Pipeline
1a Process medium
3 Measurement module
4 Control, data acquisition and processing module
5a Direction arrow
5 Wire-free communication interface
6 Sensor/actuator unit
8 Sensor
10 Field device
11 Housing
11a Field device face facing the process
11b Field device face facing away from the process
11c Field device face facing away from the process
11d Field device face facing away from the process
12 Connecting means
13 Hollow cylindrical attachment
14 Thermoelectric transducer
14b Transducer face facing the process
14c Transducer face facing away from the process
15 Heat flow
16 Heat conduction means on the environment side
17 Heat conduction means on the process side
18 First material
19 Second material
20 Heat sink
20a Hollow cylindrical attachment
20b Cylindrical disc
20c Circular cylindrical ring
21 Cooling rib
22 Controller
24 Energy store
25 Converter rectifier
26 Heat shield

1. An arrangement for supplying electrical power to a field device with a housing for monitoring a technical process in a process installation, in which there are pipelines which carry process media, without the use of wires, which field device has a wire-free communication interface has at least one field device face facing the process and at least one field device face facing away from the process, and is equipped with a thermoelectric transducer which has a transducer face facing the process and a transducer face facing away from the process, wherein the thermoelectric transducer is arranged in or on the field device outside the pipeline carrying the process media, such that the heat flow in the field device between the field device face (facing the process and the field device face facing away from the process and/or heat flow through the thermoelectric transducer between the transducer face facing the process and the transducer face facing away from the process is converted to electrical energy by the thermoelectric transducer.

2. The arrangement as claimed in claim 1, wherein the heat flow in the field device between the field device face facing the process and the field device face facing away from the process, and/or the heat flow through the thermoelectric transducer between the transducer face facing the process and the transducer face facing away from the process can be converted to electrical energy irrespective of the direction of the heat flow.

3. The arrangement as claimed in claim 1, wherein the thermoelectric transducer is connected to a heat sink on the transducer face facing away from the process.

4. The arrangement as claimed in claim 3, wherein the thermoelectric transducer is fitted entirely within the housing and the heat sink is fitted at least partially within the housing.

5. The arrangement as claimed in claim 3, wherein the field device is equipped with an energy store and an energy management system, which is integrated in a controller or in a control, data acquisition and processing module.

6. A method for supplying electrical power to a field device with a housing for monitoring a technical process in a process installation, in which there are pipelines which carry process media, without the use of wires, which field device has a wire-free communication interface, has at least one field device face facing the process and at least one field device face facing away from the process, and is equipped with a thermoelectric transducer which has a transducer face facing the process and a transducer face facing away from the process, wherein heat flow in the field device between the field device face facing the process and the field device face facing away from the process and/or heat flow through the thermoelectric transducer between the transducer face facing the process and the transducer face facing away from the process is converted to electrical energy by the thermoelectric transducer.

7. The method as claimed in claim 6, wherein the heat flow in the field device between the field device face facing the process and the field device face facing away from the process, and/or the heat flow through the thermoelectric transducer between the transducer face facing the process and the transducer face facing away from the process is converted to electrical energy irrespective of the direction of the heat flow.

8. The method as claimed in claim 7, wherein a defined path for the heat flow in the field device is created by a heat sink which is fitted on the transducer face facing away from the process.

9. The method as claimed in claim 8, wherein energy consumption of the field device is minimized by an energy management system, with the energy management system being integrated in a controller or in a control, data acquisition and processing module, and being connected via the wire-free communication interface with a central control and/or service station.

10. The method as claimed in claim 9, wherein the energy consumption of the field device is minimized as a function of a state of an energy store which is arranged in the field device, and/or of actual measurement variables and/or of their rate of change with time and/or of an instantaneous installation state, which is known to the central control and/or service station.

11. The arrangement as claimed in claim 2, wherein the thermoelectric transducer is connected to a heat sink on the transducer face facing away from the process.
